(19) United States
(12) Patent Application Publication
(10) Pub. No.: US 2011/0297481 A1
(43) Pub. Date: Dec. 8, 2011

(54) PIVOTING HUNTING TREE STAND

(76) Inventor: William J. Copus, Mt. Horeb, WI (US)

(21) Appl. No.: 13/154,571

(22) Filed: Jun. 7, 2011

Related U.S. Application Data
(60) Provisional application No. 61/352,240, filed on Jun. 7, 2010.

(51) Int. Cl. A01M 31/02

(52) U.S. Cl. 182/113; 182/187; 182/188

(57) ABSTRACT

A hunter's tree stand for attachment to a tree includes two major components: a support frame and a seat assembly removably and rotatably mounted to the support frame, wherein the seat assembly comprises a seat and a foot platform.

### CROSS-REFERENCE TO RELATED APPLICATION

The application claims priority to U.S. Provisional Application entitled “Pivoting Hunting Tree Stand,” Ser. No. 61/352,240, filed Jun. 7, 2010, which is incorporated herein by reference in its entirety.

### FIELD OF THE INVENTION

The present invention relates to a tree stand primarily for hunting and more particularly to a portable pivoting hunting tree stand attachable to a tree or other vertical support.

### BACKGROUND

In one common hunting technique, the hunter takes position on a platform and/or seat attached to a tree, e.g., a tree stand or tree seat, from which the hunter scans the surrounding area for his prey. Portable tree stands and tree seat blinds provide advantages to hunters in terms of concealment and comfort while awaiting the appearance of game and during the process of following an animal with a firearm during aiming and shooting. In particular, portable tree stands and seats provide an improved vantage point when hunting various game, such as deer and other big game species. The elevated position reduces human odor near the ground, which can alert potential game of the hunter's presence, and provides better sight lines for the hunter. Further, the elevated position allows a hunter more movement while hunting without alerting potential game to the hunter's location. However, portable tree stands allow hunters, particularly archers, only a limited effective shooting area or field of fire.

In its basic form, the tree stand is a platform which is attached to a tree, pole or other vertical post using straps, ropes, chains and the like to secure the tree stand to the tree. Most stands are secured to the tree at heights from a few feet up to 20 or more feet in the air.

There are a variety of tree stands known to the art. They can come in a form similar to tree house on stilts. In addition, the ladder stands are known. As the name implies, this type of tree stand is attached to the end of a ladder which is secured to the tree. The hunter then climbs the ladder to the stand attached to the end of the ladder and now resting next to the tree at some distance from the ground. A similar stand, the climbing stand, incorporates a modified type of ladder with a chair and platform attached to it. Unlike the ladder stand, the climbing stand allows the hunter to “climb” tree in measured movements up the climbing stand until the hunter has reached a desired height. A third type of stand is the stand-alone, hanging stand, popular because of its versatility. The hanging stand generally includes a seat and a footrest, both attached to the tree by straps, ropes and the like. These stands must be previously mounted to the tree by using ladders, pulleys and the like. To use the stand, the hunter requires a separate ladder or climbing stick to ascend to the tree stand.

All tree stands typically have a foot platform, generally an extended shelf for the hunter's feet, and a seat assembly. Most tree stands are immobile, meaning the neither the foot platform nor the seat assembly can move once the stand has been secured to the tree. This sometimes presents a dilemma to the hunter as this particular type of stand restricts the hunter's range of motion for ideal targeting. Essentially, the hunter has a limited range of left/right motion about the tree. In addition, the immobile tree stand creates certain dangers if the hunter needs to stretch substantially to his/her left or right in order to take a shot at a target. It puts the hunter in an awkward position several feet up in the air, which could be dangerous.

In an effort to compensate for this, tree stands with some mobility have been developed. For example, U.S. Pat. Nos. 4,784,239 to Kirkman; 5,269,395 to Lyzhoft et al; 5,996,738 to Nelson; 5,482,137 to McNeill; 4,290504 to Cuba; and U.S. Published Patent Application 2009/0321186 to Louchart all disclose tree stands with rotatable seats. However, these tree stands are only directed to rotating seat assemblies. The foot platform remains immobile therefore requiring added effort and noise on the part of the hunter as he/she attempts to rotate about the seat mechanism.

One reference, US Published Patent Application 2007/0114096 to Skipper, discloses a portable modular ladder and tree stand placed upon a ladder like device, which is supported to a tree or other upright. The tree stand is attached to the ladder support by means of an extension to form a pivot joint. In this manner, the tree stand, which includes the seat connected to the platform is rotatably mounted and free to pivot about the pivot joint. However, the purpose for pivoting is only to allow the placement and securing of the stand with respect to the supporting tree. Once the stand has been pivoted such that it is secured against the tree, it is immobilized and cannot be rotated during the hunting operation.

Thus, there is a need for a more versatile tree stand which will allow the hunter greater hunting flexibility and view of the area without compromising the hunter's safety, as well as a wider range of firing angles and more comfort on the tree stand.

### SUMMARY OF THE INVENTION

An exemplary embodiment relates to a tree stand comprising a support frame adapted for attachment to a vertical object, a platform and seat assembly, and wherein the platform assembly is coupled to the frame with a swivel attachment. The seat assembly includes a seat and a foot platform.

The invention is further directed to a tree stand for attachment to a tree or the like comprising a support frame and a seat assembly. The support frame includes a base support structure, wherein the base support structure includes a generally horizontally positioned mounting plate with mounting plate openings situated in a semi-circular fashion around a seat assembly receiving joint, and an elevated secondary support structure, wherein the base support structure is positioned at a distance sufficient to fixedly mount the seat assembly. The seat assembly is rotatably mounted to the support frame and includes a seat, a foot platform, and a foot pedal, wherein the foot pedal interacts with the mounting plate openings to adjust the position of the seat assembly with respect to the support frame. The tree stand further includes strap mounts to receive straps in order to attach the tree stand to the tree.

The present invention advantageously provides a tree stand with two easily attachable components, wherein the support mount can be secured to a tree first without the necessity or the weight of the seat assembly attached to it. Once the support mount has been attached, the seat assembly can be easily secured to it. Therefore, it is easy to set-up and take down.

In addition, the support mount can remain on the tree without the seat assembly. In this manner, the hunter can remove the seat assembly at the conclusion of the hunt and take the seat assembly away, leaving the support mount on the tree for later use. The seat assembly can be folded to a relatively flat position for ease in transportation and storage.

The present invention also provides a unique rotatable tree stand wherein both the foot platform and the seat are rotatably mounted on the support mount. In this manner the hunter can rotate the seat assembly about a pivot point giving the hunter a forward directional angle of view of at least 270°, which adds both to the hunter's safety and comfort.

The objects and advantages of the invention will appear more fully from the following detailed description of the preferred embodiment of the invention made in conjunction with the accompanying drawings.

### BRIEF DESCRIPTION OF THE DRAWINGS

FIG. 1 is a forward perspective view of the hunting tree stand of the present invention.

FIG. 2 is a rearward perspective view of the hunting tree stand of the present invention.

FIG. 3 is a perspective view of the support frame of the tree stand.

FIG. 4 is an exploded perspective view of the support frame attached to a tree and a positioning ladder.

FIG. 5 is a perspective view of the support frame attached to a tree with the positioning ladder attached thereto.

FIG. 6 is a partially exploded perspective view of the support frame of FIG. 5.

FIG. 7 is a side elevated view of the hunting tree stand attached to a tree illustrating the positioning of a securing pin.

FIG. 8 is a side elevated view of the hunting tree stand attached to a tree.

FIG. 9 is a rearward perspective view of the hunting tree stand attached to a tree illustrating the rotational positioning of the seat assembly with respect to the support stand.

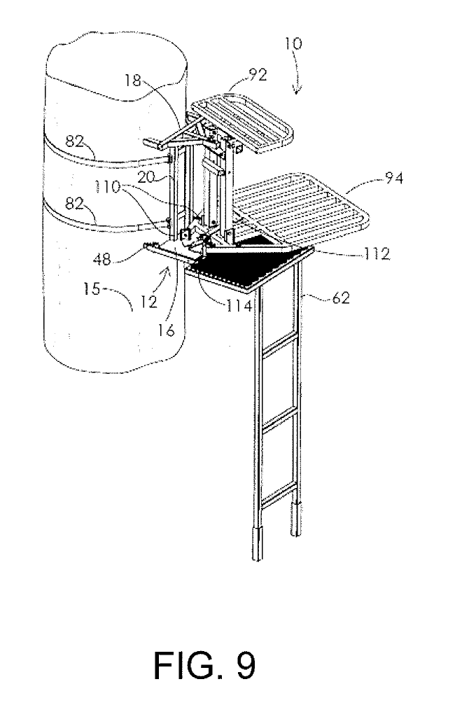

### DETAILED DESCRIPTION OF THE INVENTION

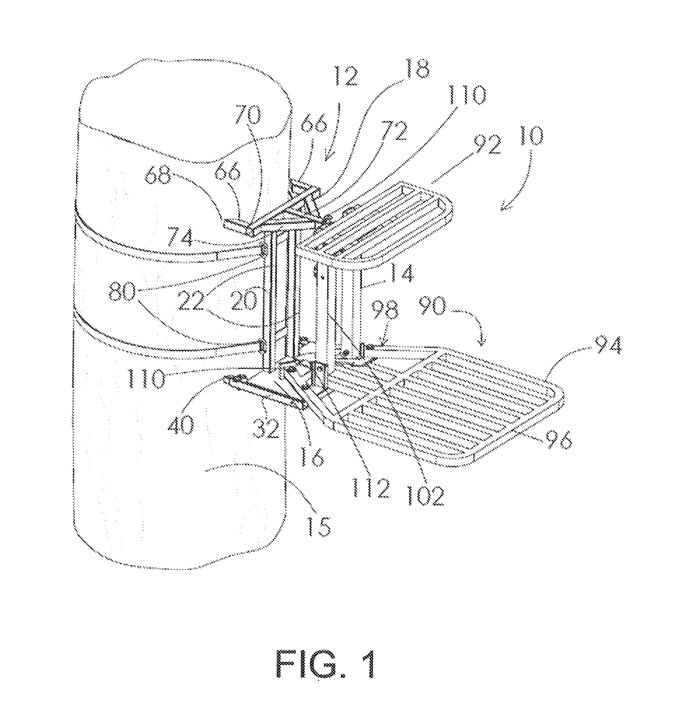

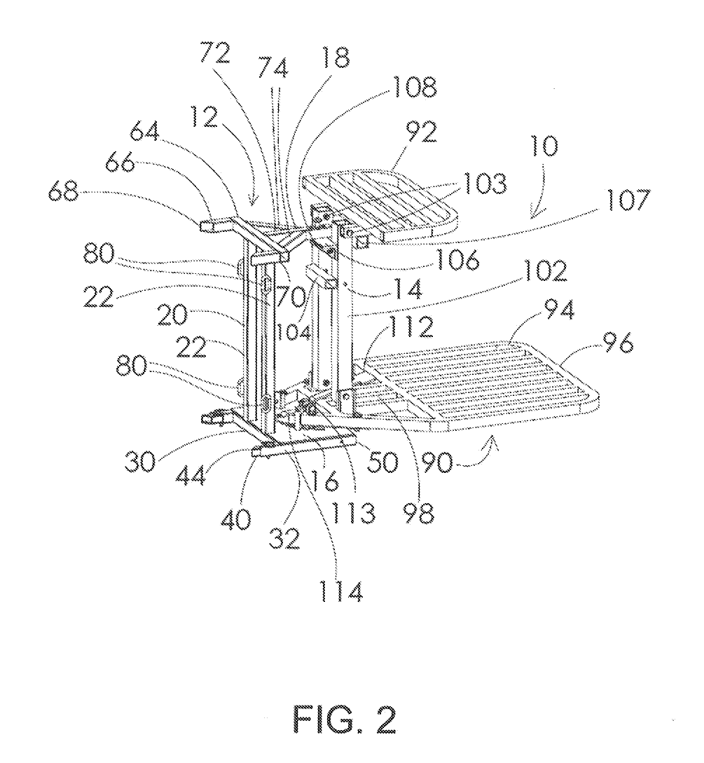

Referring now to FIGS. 1 and 2, the hunting tree stand 10 of the present invention is illustrated as comprising two basic components (1) a support frame 12 and (2) a seat assembly 14 which is rotatably mounted on the support frame 12. As illustrated, the tree stand 10 is mounted to a vertically extending support structure 15, such as a tree. For purposes of the present invention and to assist in clarity, the term “vertically extending support structure 15” will be called a “tree.” Examples of other types of vertically extending structures include telephone poles, posts, towers and the like.

With reference to FIGS. 1-3, the support frame 12 includes a base support structure 16 and an elevated secondary support structure 18, both of which are fixedly mounted to an secondary support structure extension 20 which can be made of a pair of spaced apart and generally vertically extending tubular supports 22 which position the base support structure 16 and the secondary support structure 18 at a distance sufficient to fixedly mount the seat assembly 14.

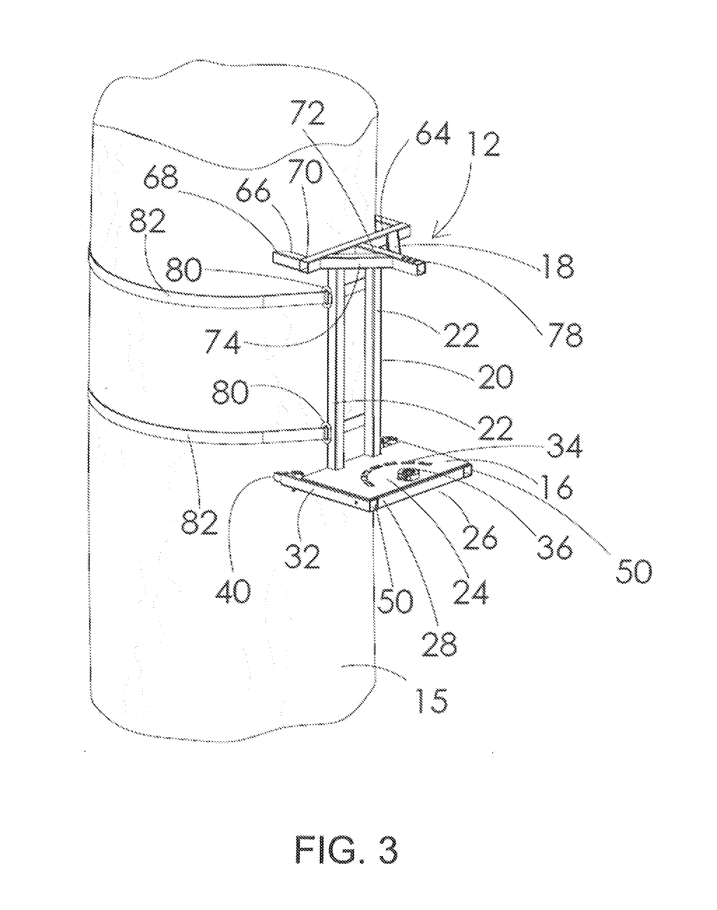

As illustrated in FIG. 3, the base support structure 16 includes a generally horizontally positioned mounting plate 24 mounted to a framework 26 which includes a front support 28, a rear support 30 and two parallel placed side supports 32.

The mounting plate 24 includes a series of mounting plate openings 34 situated in an arcuate or semi-circular fashion around a seat assembly receiving joint 36, which is a swivel bearing comprising an opening 37 through the mounting plate 24, on which the seat assembly 14 may be inserted and seated to couple the support frame 12 and seat assembly 14 together as illustrated in FIGS. 1-2. The seat assembly receiving joint 36 acts as a swivel bearing to rotatably receive the lower engagement pin 38 of the seat assembly 14 which is rotatable within the opening 37.

As illustrated in FIG. 3, the side supports 32 include anchors 40 designed to affix the tree stand 10 to the tree 15. Each anchor 40 is preferably sharpened or angled to provide a point of enhanced engagement establishing a more secure engagement to the tree 15.

As illustrated in FIGS. 1-2, the first end 40 of the side supports 30 can include an support extension 44 which is slidably received within the interior of the first end 40 to enable adjustment of the support frame 12 with respect to the tree 15 in order to provide an added measure of positioning and alignment with respect to the shape and angle of the tree 15. In this manner, the support frame 12 can be mounted to the tree 15 at a preferred angle, preferably vertically disposed with respect to the ground. The support extensions 44 include one or more support extension openings 46 for adjustably positioning the support extensions 44 within the side supports 32 by the use of locking pins 48. As illustrated in FIGS. 1-2, the side supports 32 of the mounting plate 24 also include a side support opening 50. By positioning the support extension openings 46 and a side support opening 50, the locking pin 48 can be placed therebetween to lock the support extensions 44 within the side support 32 at a proper distance for locating the support frame 12 to the tree 15 in the manner specified.

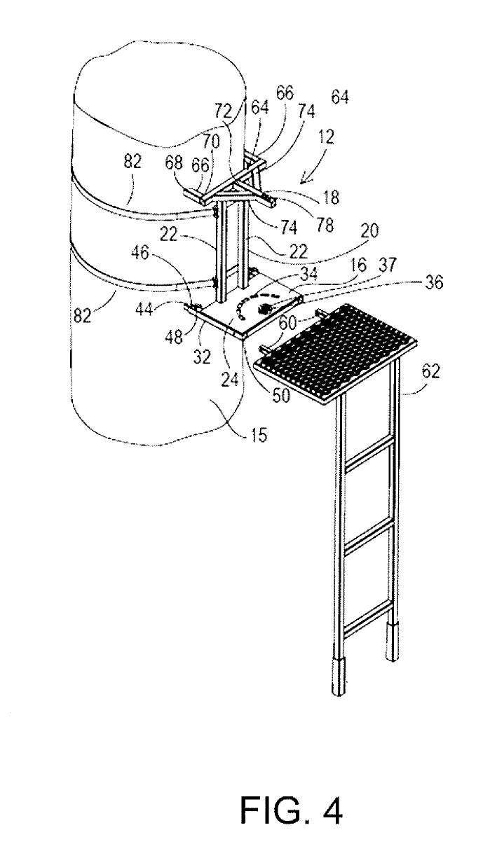

The opposite ends of the side supports 32 of the mounting plate 24 are also preferably opened at 50 to receive ends 60 of a mounting ladder 62 (See FIG. 4), which will be described shortly.

Likewise, the upper or secondary support structure 18 includes a base support 64 fixedly mounted to support mounts 66. Preferably, the support mounts 66 have an angled first end 68 for positioning the secondary support structure 18 against the tree 15 in a gripping manner. The second end 70 is fixedly mounted to the base support 64. Extending from the base support 64 in the opposite direction is the seat assembly support bar 72 bracketed and supported by two angled support bars 74. As illustrated in FIGS. 2 and 3, the support bar 72 includes one or more openings 78 for adjustably locking the seat assembly 14 at various angles. The purpose and advantage of having multiple openings 78 is to allow adjustment of the positioning of the seat assembly 14 in order to accommodate an unusual angle of the tree 15. In this manner, the seat assembly 14 can maintain a relatively vertical angle with respect to the ground even though the tree 15 may have an unusual angle.

Located on the support mounts 22 are upper and lower strap mounts 80 for the purpose of receiving straps 82 in order to attach the hunting stand 10 to the tree 15.

Referring now FIGS. 1-2, the seat assembly 14 comprises two major features: the foot platform 90 and the seat 92. The foot platform 90 includes a planer generally perforated shelf 94 for the user, i.e., hunter, to place his/her feet. The foot platform 90 can be of any desired shape, but is generally circular, ellipsoid or rectangular. Likewise, the foot platform 90 is preferably perforated to assist in drainage, but can be solid if desired. The shelf 94 has a first extension end 96 and a second attachment end 98 with a downwardly protruding post 100 which is designed to rotatably mount within the seat assembly receiving joint 36 in the mounting plate 24 of the support frame 12.

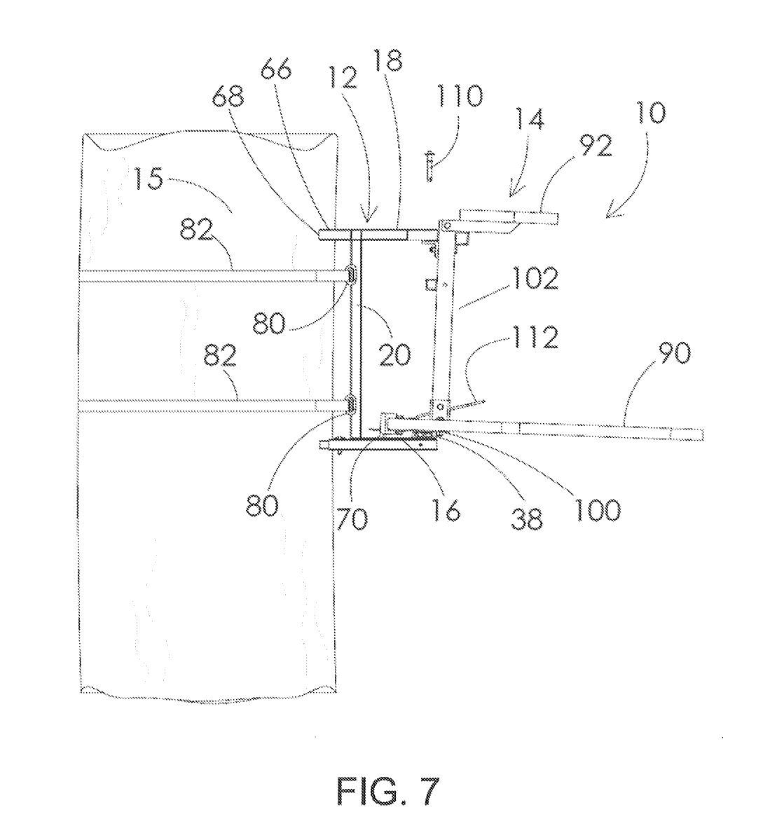

The foot platform 90 also includes generally upright tubular mounting posts 102 attached to the foot platform 90 at a location near the mounting plate 24. Situated at the upper, other end of the mounting posts 102 is the hunter's seat 92. This seat 92 can be either rotatably or fixedly mounted to the upper portion of the upright mounts 102 at the location of the seat hinge bolts 103. Located between the upright mounts 102 is a support mount 104 for adding integrity to the mounting posts. In addition, there is a seating mount 106. The seating mount 106 is defined by a seating mount opening 108 in the middle of the seating mount 104 to coincide with the openings 78 on the secondary support bar 76 of the secondary support structure 18 of the mounting plate 24. A pin 110 (FIG. 7) can then be placed such that it penetrates both the openings 78 of the secondary support bar of the secondary support structure 18 and the opening 108 of the seating mount 106 in order to lock the seat assembly 14 in place on the mounting plate 24, as well as stabilizer bar 107. It is important to note that the seat assembly 14 is locked in place by only the action of the mounting post 100 within the receiving joint 36 and the pin 110 receivably connecting the secondary support structure 18 to the seating mount 106. In this manner, the seat assembly 14 is rotatably mounted on the mounting plate 24.

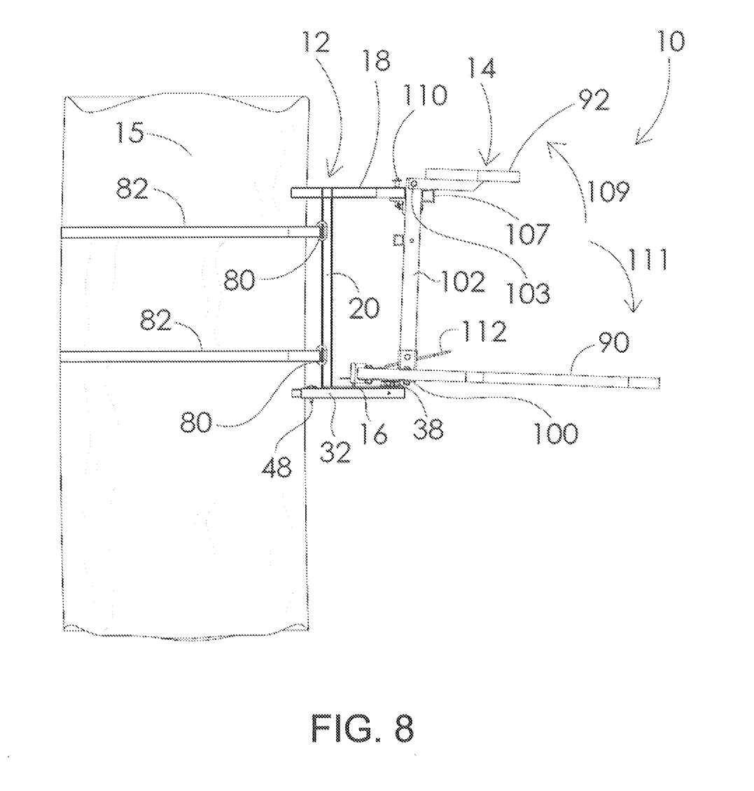

The seat 92 has the capability of being rotated in a upwardly fashion along arrow 109, illustrated in FIG. 8, because of the seat hinge bolts 103 which allow the seat to rotate upwardly to a vertical position in case the hunter wishes to displace the seat 92 in order to stand. In the seated position, the seat 92 rests upon to stabilizer bar 107 which prevents the seat from dropping farther than the horizontal position illustrated in FIGS. 1, 2 and 8. Likewise, the upright tubular mounting posts 102 may be hingedly attached to the foot platform 90 at the location of the foot platform hinge bolts 91. In this manner, the seat 92 and mounting posts 102 can rotate forwardly along the direction of arrow 111, illustrated in FIG. 8, such that the seat 92 and mounting posts 102 are in parallel position with respect to the foot platform 90 for ease of transportation and storage.

Also included on the seat assembly 14 at the area of the planer shelf 94, is a preferably spring-loaded foot pedal 112 which includes a tab or detent 114 which can be received within the mounting plate openings 34 on the base support structure 16 to arrest the rotational movement of the seat assembly 14 about the support frame 12. The foot pedal 112 is spring loaded by means of a spring at location 113 in such a manner that when the foot pedal 112 is activated by the hunter pressing the pedal 112 toward the foot platform 90, the detent 114 will be lifted out of a mounting plate opening 34. At that point, the seat assembly 14 is free to rotate about the receiving joint 36. When the seat assembly 14 is positioned to the user's liking, the foot pedal 112 can be released. The action of the spring at location 113 will urge the detent 114 to be lockingly placed within another mounting plate opening 34.

It is within the scope of the present invention to also include a battery or electrically operated rotation device (not illustrated) for automatically rotating the seat assembly 14 with respect to the mounting plate 24. In addition, it is within the scope to include disk brakes or other braking attachments (not illustrated) to replace the mounting plate openings 34. The advantage to the disk brake structure is that it will be activatable with little or no noise as there are no pins or locking structures to be placed within the mounting plate openings 34.

With respect to the spring loaded foot release, the pedal 112 will release the locking mechanism enabling the hunting stand 10 to rotate about the seat assembly receiving joint 36. At the proper location, the foot pedal 112 will be slowly released allowing the detent 114 to fall within one of the mounting plate openings 34 to lock the seat assembly 14 in its position

Advantageously, the mounting system of the seat assembly 14 on the support frame 12 enables the user to rotate the seat assembly 14, consisting of both the seat 92 and the foot platform 90 with a range of rotation which could extend 270° or more, depending on the size of the tree 15 or upright structure.

While not shown, it is within the scope of the present invention and designed to include a safety rail on the hunt seat assembly 14. The safety rail can be permanently affixed or it can be manufactured such that one end includes a hinge and the other end includes a locking device for opening the safety rail in order to allow the hunter to enter and stand or sit on the hunt seat mechanism before closing the safety rail.

The seat assembly 14 is generally mounted in one of two ways, either by a pulley system or a ladder system.

With the pulley system, the user must use a ladder (a regular ladder will do) to climb the tree 15 to the desired location. A pulley is then mounted to the tree 15 using straps and winching. The user then climbs down the ladder, attaches the support frame 12 to one end of the rope which is attached to the pulley. With the other end, the user will pull the rope thereby lifting the support frame 12 to the location of the pulley on the tree 15. Once the support frame 12 is in position on the tree 15, the user again climbs the ladder and straps the support frame 12 to the tree 15 using mounting straps 82 positioned within the strap mounts 80. Once the support frame 12 has been secured to the tree 15, the seat assembly 14 can then be attached to the pulley rope and elevated to the area of the support frame 12 in similar fashion. Once the seat assembly 14 is positioned near the support frame 12, the user again climbs the ladder and positions the downwardly protruding post attached to the seat assembly 14 within the seat assembly receiving joint 36. The seating mount 106 must then be secured to the secondary support bar of the mounting plate 24 by positioning the openings on the secondary support bar over the opening of the seating mount 106 and securing the two together by means of the pin 110. Once the pin 110 has been activated, the seat assembly 14 is then rotatably mounted on the mounting plate 24. The foot pedal 112 can then be activated which causes the detent 114 to be positioned within one of the openings 34 on the mounting place 24 of the base support structure 16. The rotating hunt seat 92 is then positioned on the tree 15 for use.

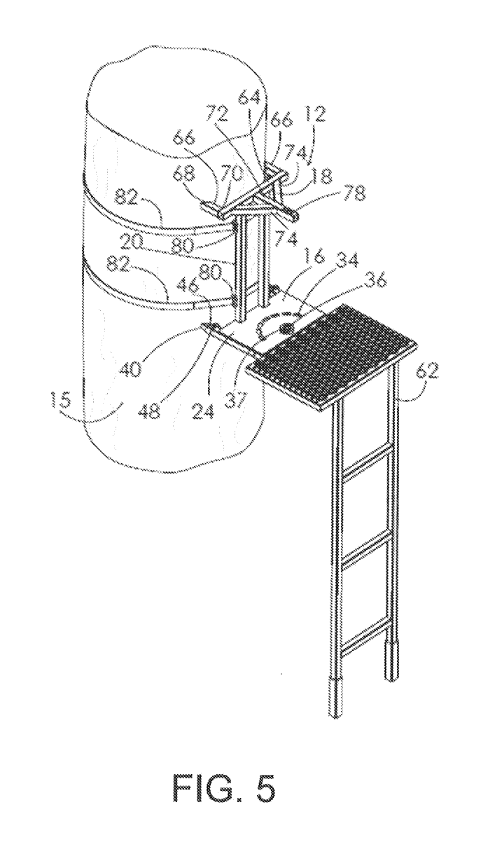

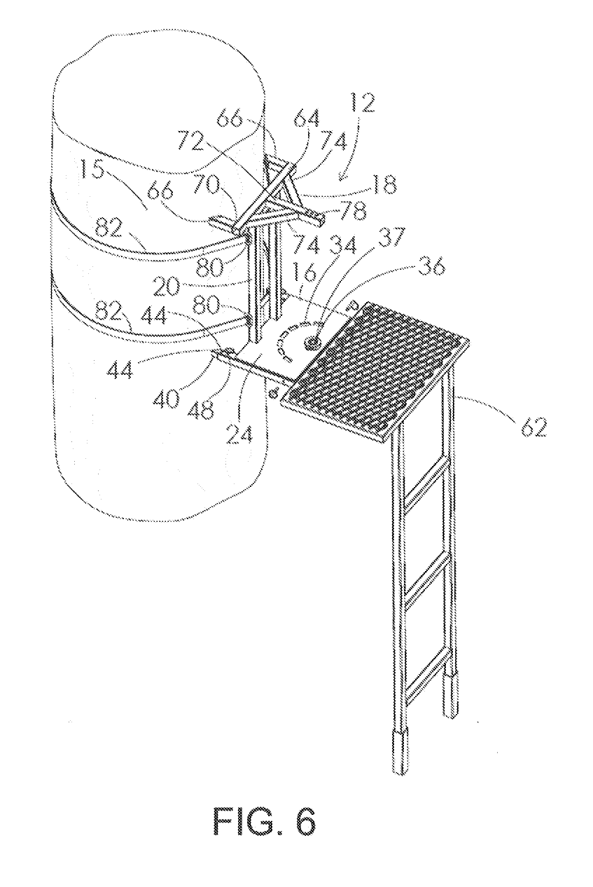

Alternatively and referring to FIGS. 4-7, a ladder 62 can be used to position the seat assembly 14 to the tree 15. In this manner, a ladder 62 includes two extensions 60 at one end 63 of the ladder 62 for placement within the openings on the base support structure 16 of the mounting plate 24. The extensions include an opening which is receivably positioned at an opening 34 on the side supports 32. Pins 110 are then placed within the openings 34 to lock the ladder 62 to the support frame 12. The ladder 62 is then elevated with respect to the tree 15 and the support frame 12 is located at a distance and height approximating the length of the ladder 62. For safety sake, the ladder 62 is typically positioned such that it is at an angle with respect to the support frame 12. The user then climbs the ladder 62 to reach the support frame 12 and attaches the support frame 12 to the tree 15 using support straps 82 in a similar manner to that with respect to the pulley system. Once the support frame 12 has been mounted to the tree 15, the user can then elevate the seat assembly 14 and attach it to the mounting plate 24 in a similar manner as that described with the pulley system. The rotating hunter seat 10 is then available for use.

It is within the scope of the present invention, and indeed an advantage of this invention, that the support frame 12 can remain on the tree 15 even if the seat assembly 14 is removed, as illustrated in FIG. 3. In this manner, the seat assembly 14 can be removed when the user is finished with the operation of the assembly. The support frame 12 can remain on the tree 15 for future use at a later time.

The tree stand of the present invention is preferably made of a light material, such as aluminum, to keep the weight of the stand manageable for transportation and assembly. It is within the scope of the present invention to use other metals and non-metal materials for all or part of the tree stand.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that references to relative positions, e.g., “top” and “bottom,” in this description are merely used to identify various elements as are oriented in the figures. It should be recognized that the orientation of particular components may vary greatly depending on the application in which they are used.

It is also important to note that the construction and arrangement of the pivotable hunting tree stand, as shown in the various exemplary embodiments, is illustrative only. While the pivotable hunting tree stand according to this invention has been described in conjunction with the exemplary embodiments outlined above, various alternatives, modifications, variations, improvements, and/or substantial equivalents, whether known or that are or may be presently unforeseen, may become apparent. Accordingly, the exemplary embodiments of the pivotable hunting tree stand, according to this invention, as set forth above, are intended to be illustrative, not limiting. Various changes may be made without departing from the spirit and scope of the invention. Therefore, the description provided above is intended to embrace all known or later-developed alternatives, modifications, variations, improvements, and/or substantial equivalents.

Any version of any component or method step of the invention may be used with any other component or method step of the invention. The elements described herein can be used in any combination whether explicitly described or not.

All combinations of method steps as used herein can be performed in any order, unless otherwise specified or clearly implied to the contrary by the context in which the referenced combination is made.

As used herein, the singular forms “a,” “an,” and “the” include plural referents unless the content clearly dictates otherwise.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, and peer-reviewed publications (i.e., “references”) cited herein are expressly incorporated by reference in their entirety to the same extent as if each individual reference were specifically and individually indicated as being incorporated by reference. In case of conflict between the present disclosure and the incorporated references, the present disclosure controls.

The devices, methods, compounds and compositions of the present invention can comprise, consist of, or consist essentially of the essential elements and limitations described herein, as well as any additional or optional steps, ingredients, components, or limitations described herein or otherwise useful in the art.

While this invention may be embodied in many forms, what is described in detail herein is a specific preferred embodiment of the invention. The present disclosure is an exemplification of the principles of the invention is not intended to limit the invention to the particular embodiments illustrated. It is to be understood that this invention is not limited to the particular examples, process steps, and materials disclosed herein as such process steps and materials may vary somewhat. It is also understood that the terminology used herein is used for the purpose of describing particular embodiments only and is not intended to be limiting since the scope of the present invention will be limited to only the appended claims and equivalents thereof.

What is claimed is:

1. A tree stand for attachment to a tree or the like, comprising:
a. a support frame, and
b. a seat assembly rotatably mounted to the support frame, wherein the seat assembly comprises a seat and a foot platform.

2. The tree stand of claim 2 wherein the support frame includes:
a. a base support structure and
b. an elevated secondary support structure, wherein the base support structure is positioned at a distance sufficient to fixedly mount the seat assembly.

3. The tree stand of claim 2 wherein the base support structure includes a generally horizontally positioned mounting plate, wherein the mounting plate further includes mounting plate openings situated in a semi-circular fashion around a seat assembly receiving joint.

4. The tree stand of claim 1 wherein the support frame comprises at least one anchor to provide a point of enhanced engagement establishing a more secure engagement to the tree.

5. The tree stand of claim 4 wherein the anchor is slidably received within the support frame to enable adjustment of the support frame with respect to the tree.

6. The tree stand of claim 1 wherein the support frame includes openings to receive a mounting ladder.

7. The tree stand of claim 1 wherein the support frame include strap mounts to receive straps in order to attach the tree stand to the tree.

8. The tree stand of claim 1 wherein the foot platform includes a planer generally perforated shelf.

9. The tree stand of claim 8 wherein shelf includes means to mount the seat assembly.

10. The tree stand of claim 1 comprising means to releasably mount the seat assembly to the support frame.

11. The tree stand of claim 3 further including a foot pedal on the seat assembly, wherein the foot pedal interacts with the mounting plate openings to adjust the position of the seat assembly with respect to the support frame.

12. The tree stand of claim 11 wherein the foot pedal is spring-loaded.

13. The tree stand of claim 12 wherein the foot pedal includes a detent which can be removably received within the mounting plate openings on the base support structure to arrest the movement of the seat assembly about the support frame.

14. The tree stand of claim 1 wherein the seat assembly has a range of rotational motion of at least 270° with respect to the support frame.

15. The tree stand of claim 1 further comprising a safety rail affixed to the seat assembly.

16. The tree stand of claim 1 further comprising means to mount the tree stand to a tree or the like.

17. The tree stand of claim 16 wherein the means to mount the tree stand comprises a pulley system.

18. The tree stand of claim 16 wherein the means to mount the tree stand comprises a ladder system.

19. A tree stand for attachment to a tree comprising a support frame, a seat assembly and strap mounts to receive straps in order to attach the tree stand to the tree:
a. wherein the support frame includes:
i. a base support structure, wherein the base support structure includes a generally horizontally positioned mounting plate with mounting plate openings situated in a semi-circular fashion around a seat assembly receiving joint, and
ii. an elevated secondary support structure, wherein the base support structure is positioned at a distance sufficient to fixedly mount the seat assembly; and wherein
b. the seat assembly is rotatably mounted to the support frame, and comprises a seat, a foot platform, and a foot pedal, wherein the foot pedal interacts with the mounting plate openings to adjust the position of the seat assembly with respect to the support frame.

20. The tree stand of claim 19 wherein the support frame comprises at least one anchor slidably received with the support frame to provide a point of enhanced engagement establishing a more secure engagement to the tree.

21. The tree stand of claim 1 further comprising a mounting ladder, wherein the support frame includes openings to receive the mounting ladder.

22. The tree stand of claim 19 wherein the foot pedal is spring-loaded.

23. The tree stand of claim 19 wherein the foot pedal includes a detent which can be removably received within the mounting plate openings on the base support structure to arrest the movement of the seat assembly about the support frame.
